(19) United States
(12) Patent Application Publication
(10) Pub. No.: US 2026/0212728 A1
(43) Pub. Date: Jul. 23, 2026

(54) BET REQUEST ASSESSMENT SYSTEM AND METHOD

(71) Applicant: Genius Sports UK Limited, London (GB)

(72) Inventor: Alistair FLUTTER, London (GB)

(21) Appl. No.: 19/451,985

(22) Filed: Jan. 16, 2026

(30) Foreign Application Priority Data
Jan. 20, 2025 (GB) 2500771.7

(51) Int. Cl. G07F 17/32; G06Q 30/0201; G06Q 50/34

(52) U.S. Cl. CPC G07F 17/3237; G06Q 30/0201; G06Q 50/34; G07F 17/3288

(57) ABSTRACT

A method and system for assessing bet requests relating to sporting events is described. A bet request assessment system receives a request to assess a bet request from a user to place a bet on an outcome relating to a sporting event. The bet request assessment system determines, based on state data indicative of a state of play of the sporting event, an indication of whether the bet should be accepted. The bet request assessment system provides a bet assessment response in accordance with the determined indication. A system for receiving and processing bet requests is also described including a first entity for receiving bet requests from users and executing bet placement, and a bet request assessment system that processes requests from the first entity and provides bet assessment responses based on state data of the sporting event.

### CROSS-REFERENCE TO RELATED APPLICATIONS

This application claims priority to United Kingdom Application No. GB 2500771.7, filed Jan. 20, 2025, under 35 U.S.C. § 119(a). The above-referenced patent application is incorporated by reference in its entirety.

### TECHNICAL FIELD

The present disclosure relates to computer-implemented systems and methods for processing and assessing betting requests. More particularly, the disclosure relates to systems and methods for assessing bet requests relating to a sporting event based on state data indicative of a state of play of the sporting event.

### BACKGROUND

In online sports betting, customers, sometimes referred to as punters, may submit bet requests to a bookmaker, specifying a particular outcome, such as predicting the home team to win in a football match, and indicating an intended stake. Upon receiving the request, the bookmaker may evaluate whether to accept the bet based on various factors. These factors may include the bookmaker's financial exposure to the potential outcome, the customer's betting history or stake limits, and whether the odds requested by the customer are valid at the time that the bet request is received.

In certain circumstances, such as in the case of live in-play betting, the factors involved in assessing a bet request may change rapidly. For instance, developments in the sporting event, such as the scoring of a goal in football game, may result in the odds applicable to betting outcomes changing or in the betting market being suspended. This can present challenges in the assessment of bet requests, since some time may be required to update the odds and suspension information. In some cases, customers with faster access to information about the sporting event, e.g., such as those present at the event or connected to rapid data feeds, may attempt to exploit this by placing bets on outcomes influenced by recent developments before bookmakers can adjust odds or suspend betting. For example, a punter at a cricket match might wait for a significant development, like a wicket, to confirm a bet at outdated odds.

One way to address this issue is for a bookmaker to implement an automatic delay in processing live bets. This delay, of, for example, a few seconds, provides a buffer to update odds or suspend betting as necessary. However, this approach has drawbacks. For example, a significant proportion of bets may be rejected due to odds changes during the delay period even when no significant event has occurred, causing frustration for customers and potential loss of revenue for bookmakers.

### SUMMARY

According to a first aspect of the present invention, there is provided a computer-implemented method of assessing a bet request, the method comprising: receiving, at a bet request assessment system, a request to assess a bet request, the bet request being a request from a user to place a bet on an outcome relating to a sporting event; determining, at the bet request assessment system, based on state data indicative of a state of play of the sporting event, an indication of whether the bet should be accepted; and providing, by the bet request assessment system, a bet assessment response in accordance with the determined indication.

The request to assess the bet request may be received by the bet request assessment system from a first entity configured to receive bet requests from users and to execute bet placement, and the bet request assessment system may provide the bet assessment response to the first entity.

The first entity may be a part of a bookmaker platform, and the bet request assessment system may be external to the bookmaker platform.

The first entity and the bet request assessment system may each form part of a bookmaker platform.

The determining the indication of whether the bet should be accepted may be based on a likelihood, determined based on the state data, of, in a pre-defined time interval following a time of the receiving the request to assess the bet request, the state data developing in a manner indicative of a significant development in the sporting event. A significant development in the sporting event may be a development which would affect an estimated probability associated with the outcome.

The method may comprise determining that the bet should be accepted if the likelihood is determined to be below a given likelihood threshold.

The determining the likelihood of the state data developing in a manner indicative of a significant development in the sporting event may comprise: determining a likelihood of the state data developing in a manner which would change an estimated probability associated with the outcome by a threshold amount.

The determining the indication of whether the bet should be accepted may comprise applying a trained machine-learning model to the state data.

The determining the indication of whether the bet should be accepted may be based on one or more of: bet request data relating to a characteristic of the bet request; market data relating to the outcome to which the bet relates; customer data relating to the user; and risk management data relating to an entity being requested to accept the bet.

The risk management data may comprise one or more of: information indicative of existing liabilities, with respect to the sporting event, of the entity being requested to accept the bet; and information indicative of one or more risk preferences, with respect to the sporting event, of the entity being requested to accept the bet.

The determining the indication of whether the bet should be accepted may comprise: determining, based on the state data, that the bet should not be accepted at least until expiry of a delay period.

The determining that the bet should not be accepted at least until expiry of a delay period may further be based on one or more of: bet request data relating to a characteristic of the bet request; market data relating to the outcome to which the bet request relates; customer data relating to the user; and risk management data relating to an entity being requested to accept the bet.

The method may comprise determining a duration of the delay period based on one or more of: the state data relating to the state of play of the sporting event; bet request data relating to a characteristic of the bet request; market data relating to the outcome to which the bet request relates; customer data relating to the user; and risk management data relating to an entity being requested to accept the bet.

The method may comprise: responsive to expiry of the delay period, determining, based on the indication of the bet request and the state data, a further indication of whether the bet should be accepted, and the bet assessment response may be in accordance with the further indication.

The determining the indication of whether the bet should be accepted may comprise: determining, at or before a time of the determining the indication and based on the state data, a confirmation status of a provisional result of a passage of play in the sporting event.

The confirmation status may be indicative of one or more of: that the provisional result has been confirmed and thereby become a confirmed result; that the provisional result has been negated; and that confirmation of the provisional result remains pending.

The bet request may be a request to place a bet on the outcome at provisional odds whose validity is conditional upon the provisional result of the passage of play in the sporting event becoming a confirmed result.

The method may comprise: providing the provisional odds to the user or to an entity configured for providing odds to the user.

The bet request may be a request to place a bet on the outcome at the provisional odds, and the determining the indication of whether the bet should be accepted may comprise determining, at or before the time of the determining the indication and based on the state data, the confirmation status of the provisional result of the passage of play.

The method may comprise one or more of: responsive to determining that the confirmation status indicates that the provisional result has become a confirmed result, determining that the bet should be accepted; responsive to determining that the confirmation status indicates that the provisional result has been negated, determining that the bet should not be accepted; and responsive to determining that the confirmation status indicates that confirmation of the provisional result remains pending, determining that the bet should not be accepted at least until expiry of a delay period or that the bet should be rejected.

According to a second aspect of the present invention, there is provided a non-transitory computer-readable storage medium including instructions that, when executed, cause one or more processors of a bet assessment system to perform a method of assessing a bet request, the method comprising: receiving, at the bet assessment system, a request to assess a bet request, the bet request being a request from a user to place a bet on an outcome relating to a sporting event; determining, at the bet assessment system, based on state data indicative of a state of play of the sporting event, an indication of whether the bet should be accepted; and providing, by the bet assessment system, a bet assessment response in accordance with the determined indication.

According to a third aspect of the present invention, there is provided a system for receiving and processing bet requests, the system comprising: a first entity for receiving bet requests from users and for executing bet placement with respect to the received bet requests; and a bet request assessment system; the system for receiving and processing bet requests being configured to: receive, at the first entity, a bet request from a user, the bet request being a request to a place a bet on an outcome relating to a sporting event; send, from the first entity to the bet request assessment system, a request to assess the bet request; receive, at the bet request assessment system, from the first entity, the request to assess the bet request; determine, at the bet request assessment system, based on state data indicative of a state of play of the sporting event, an indication of whether the bet should be accepted; and send, by the bet request assessment system to the first entity, a bet assessment response in accordance with the determined indication; and receive, at the first entity, the bet assessment response.

The system may be configured to: perform, at the first entity, based on the bet assessment response, an action in response to the bet request.

According to another aspect of the present disclosure, there is provided a bet assessment system, comprising: a memory; and one or more processors configured to perform a method of assessing a bet request; the method comprising: receiving, at the bet assessment system, a request to assess a bet request, the bet request being a request from a user to place a bet on an outcome relating to a sporting event; determining, at the bet assessment system, based on state data indicative of a state of play of the sporting event, an indication of whether the bet should be accepted; and providing, by the bet assessment system, a bet assessment response in accordance with the determined indication.

### BRIEF DESCRIPTION OF THE DRAWINGS

Examples of the present disclosure will now be described with reference to the accompanying drawings:

FIG. 1 is a flow diagram showing an example of a method for assessing bet requests relating to sporting events;

FIG. 2 is a flow diagram showing an example of interactions between a bet assessment system and a first entity for processing bet requests;

FIG. 3 is a flow diagram showing example steps for determining whether to accept or reject a bet based on likelihood calculations;

FIG. 4 is a flow diagram showing an example decision flow for assessing a bet request;

FIG. 5 is a sequence diagram showing interactions between a bet assessment system and a user device for providing provisional odds and assessing bet requests requesting the provisional odds;

FIG. 6 is a block diagram showing an example of a computing system for assessing bet requests relating to sporting events; and

FIG. 7 is a block diagram showing an example of a networked computing system for implementing example bet assessment and execution methods.

### DETAILED DESCRIPTION

### Method for Assessing Bet Requests

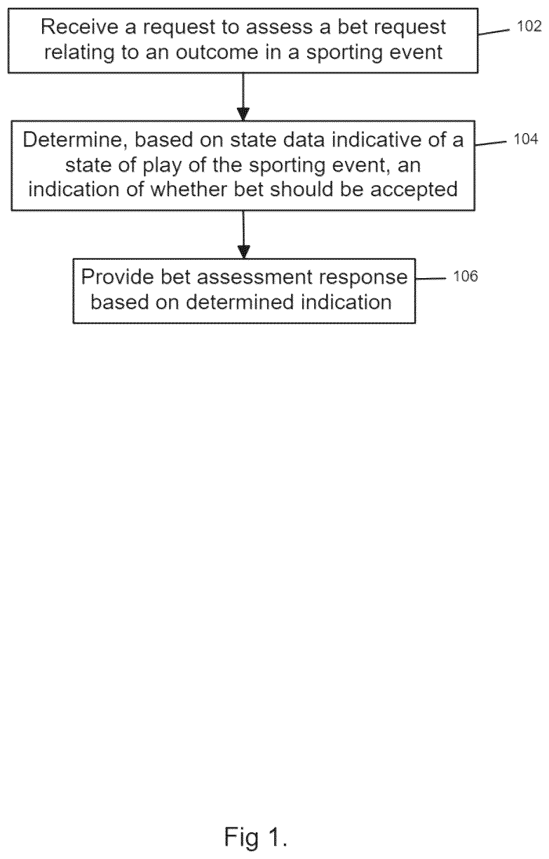

FIG. 1 shows a flow diagram illustrating a method for assessing bet requests relating to sporting events. The sporting event may, for example, be an association football (soccer) match, a cricket match, a rugby match, an American football game, a baseball game, a basketball game, a tennis match, a hockey game, or any other type of sporting event. The method may be implemented in the context of live betting, which may also be referred to as in-play betting, where users can place bets while a sporting event is in progress.

At block 102, a request to assess a bet request relating to a sporting event is received. A bet request may be submitted by a user to an entity responsible for accepting bets, e.g., a bookmaker platform, through various computing platforms, such as a smartphone application, tablet application, or web browser interface. Users may browse potential betting markets, view odds, and select outcomes through these platforms.

A betting market, referred to herein as simply a market, may relate to a particular aspect of the sporting event, such as whether the home team will win, lose, or draw, or which player will score first. Each market has one or more possible outcomes which may be selected by a user seeking to place a bet. In some examples, a given market has a plurality of outcomes available for selection. The plurality of outcomes may be mutually exclusive and exhaustive. For example, in the tennis match winner market, each of the two players participating in the match may be selectable as an outcome, with exactly one of the outcomes available for selection becoming a winning outcome.

In other examples, the selectable outcomes for a given market may not be mutually exclusive. That is, it may be possible for more than one to be a winning outcome. For example, for a market “player to score a goal”, each of the players participating in the match may be available for selection, with each selected player representing a winning outcome if that player scores a goal.

In other examples, the outcomes available for selection may not be exhaustive of all possible outcomes. For example, where the market is the exact number of goals in a football match, given that the number of goals is, in principle, unlimited, not all possible outcomes may be available for selection.

In yet other examples, a given market may contain only one selectable outcome. This may be the case, for example, where a bookmaker considers an outcome in the sporting event to be relatively unlikely to occur (for example, a given player scoring three goals) and wishes to allow bets to be placed on the outcome occurring without allowing bets to be placed on the outcome not occurring.

The bet request indicates which outcome the user wishes to bet on within a particular market. The bet request may also include details such as the stake (the amount the user wishes to bet) and the requested odds.

The odds presented to users via the bookmaker's platform may be computed internally by the bookmaker or provided by third-party odds providers, for example, through an odds feed to which the bookmaker subscribes. These odds may be updated continuously during the sporting event based on various factors, including the determined probability of outcomes, but possibly also other factors, such as risk management considerations. For example, the bookmaker's current liabilities relating to the outcome, the sporting event, or across multiple events may also be taken into account in determining the odds presented to users.

In some examples, to attempt to place a bet, a user may make a selection from the available markets and add the bet to their betting “basket”. Subsequently, the user may attempt to “check out”, e.g., involving entering their stake and depositing funds into their account. The bet request, indicating the bet that the user would like to place, including details such as the requested odds and stake, is then submitted to the bookmaker.

In some examples, a bet execution entity, e.g., operating on a bookmaker platform, is responsible for receiving bet requests from users and executing bet placement. In such examples, responsive to receiving the bet request, the bet execution entity may generate an assessment request and submit the assessment request to the bet request assessment system.

At block 104, the bet assessment system determines, based on state data relating to a state of play of the sporting event, an indication of whether the bet should be accepted. The state data comprises real-time data relating to the sporting event. For example, the state data may comprise any one or more of statistics, such as live scores and event data, video, audio and any other live data relating to the sporting event. In some examples, the state data may be acquired manually by one or more humans watching the sporting event. In other examples, the state data may be acquired automatically, for example, by a monitoring system using computer vision, or by data acquisition devices, such as location-tracking chips attached to players' clothing and/or equipment and/or to sporting equipment such as a ball. In other examples, a combination of more than one of these methods may be used.

In some examples, the determination of whether the bet should be accepted comprises applying a trained machine-learning model to the state data. A trained machine learning model may make inferences based on the state data which can be used in determining whether or not the bet request should be accepted. The trained machine learning model used for bet assessment may be implemented using various architectures and algorithms suitable for processing the input data types. The model may be periodically retrained using new training data to maintain accuracy and adapt to changing patterns in betting behaviour and sporting events.

The assessment of the bet request performed by the bet assessment system may take into account any factor or combination of factors relating to a status of the sporting event which may affect whether or not the bet request should be accepted, for example, whether play is active in the sporting event, or a score or other status of the sporting event.

In some examples, the assessment of the bet request may be based solely on the state data. However, in other examples, the assessment of the bet request may be based on other data in addition to the state data. This can enable more refined decision-making tailored to each situation. The other data taken into account may include, for example, bet request data characterising aspects of the bet itself, e.g., the requested stake, customer data associated with a user, risk management data related to the bookmaker, and market data such as odds and/or market suspension data. The weight and importance given to each type of data may be adjusted based on specific implementation requirements.

As an example, the assessment at block 104 may involve performing validation checks, such as any one or more of: that the user has sufficient funds or credit in their account to cover the requested bet; that the liability position of the bookmaker would be acceptable if the bet were accepted, for example, that accepting the bet would not cause a maximum liability limit of the bookmaker relating to the sporting event to be breached; that the requested odds match the currently offered odds; and that the market including the requested outcome is not suspended.

In some examples, the assessment may take into account whether the user submitting the bet request is considered highly valuable or highly trustworthy. In such cases, bet requests may be approved where, given the same state data, a corresponding bet request would not be accepted from a different customer not having these characteristics. Similarly, factors such as the liabilities of the bookmaker, if known to the bet request assessment system, or the stake requested may provide different bet-assessment results given the same state data. In other examples, different combinations of factors may influence the validation checks performed. For example, different maximum stake limits may be applied for different customers or different liability limits may be applied for different bookmakers.

In some examples, the assessment at block 104 may involve determining a live-play status of the sporting event at the time of the request. This determination may consider various factors such as whether the play has started, whether there is a break in play due to the end of a period (such as half-time or the end of a day's play in a multi-day format such as golf or test match cricket), or whether there is a break in play due to a stoppage, such as a rain delay. This determination may be made, for example, based on an inference made by a machine-learning model analysing real-time video, audio, or other information, or, as another example, based on an input from a human operator present at the event who provides feedback indicating when live play begins, is interrupted, or ends.

In some examples, different assessment approaches may be taken based on the determined live-play status. For example, the live-play status may influence a selection of one or more validation checks to be performed to determine the bet assessment result. For example, when play has not begun, bet requests may undergo fewer and/or more lenient validation checks since the odds are unlikely to change rapidly. Conversely, during active play, additional and/or stricter validation steps may be implemented to account for potentially fast-changing circumstances in the sporting event that could impact odds. During a stoppage following the start of play, the likelihood of rapidly changing odds may be higher than before play has begun but lower than during active play. Accordingly, in such circumstances, there may be more and/or stricter validation steps applied than before play has begun but fewer and/or more lenient validation steps than during active play.

At block 106, the system provides a bet assessment response based on the determined indication. This response may, for example, be sent to the entity that submitted the assessment request, for example, the bookmaker. The response may indicate that the bet should be accepted or rejected. The receiving entity may then take appropriate action, such as accepting or rejecting the bet. In another example, the bet assessment response may indicate that the bet should not be accepted at least until expiry of a delay period. A delay period may then be implemented before the bet request is reassessed by the bet assessment system. Users may receive notifications about the status of their bet requests, such as confirmation of bet placement, rejection notices, or waiting screens when delays are implemented.

In examples, the bet request assessment system enables dynamic evaluation of bet requests by incorporating real-time state data from sporting events. This allows the system to make informed decisions about accepting bets based on current conditions, rather than relying on static rules or historical data. This approach allows for efficient processing of bet requests while maintaining appropriate risk controls. Each bet request undergoes individualised assessment based on specific circumstances rather than applying generic processing rules, such as a universally applied delay.

To illustrate, one way to validate bet requests is to check the bet request against the latest market data at the time of submission of the bet request. For example, the requested odds may be checked against the currently offered odds and a check may be made that the market is not suspended at the time of submission of the bet request. This market data may be computed using state data relating to the sporting event. However, it is possible that due to developments in the sporting event (e.g. one team scoring), the odds requested in the bet request have become outdated or the market has been suspended by the time of submission of the bet request. Although the market data may be updated based on information indicating developments in the sporting event, this updating may take some time. As such, at the time of checking the bet request, the odds feed may not be sufficiently up to date for such a check to be safely relied upon.

In example methods described herein, by performing an assessment of a bet request based on state data relating the sporting event, that is, directly using the state data to assess the bet request as opposed to merely assessing the request based on market data, appropriate risk controls can be maintained such that unsafe bets are not accepted. Moreover, this may be achieved in a manner which provides an improved user experience and better bet acceptance statistics. For example, processing each bet request against current state data can allow most bet requests to be accepted without delay while still reducing the likelihood of accepting bets based on outdated information. This approach can reduce waiting times for users and avoid bet rejections that might otherwise occur because of changes to odds during a delay period, while maintaining appropriate risk controls.

Furthermore, in examples, certain disadvantages associated with alternative solutions, such as applying a generic delay to all requests submitted after the scheduled start time of a sporting event, may be mitigated or avoided. For example, by assessing each bet request individually against live state data, bet requests submitted during a break in play, or during a period of play when nothing having a significant impact on the outcome of the bets being requested is likely to happen in the next few seconds, may be accepted without delay, provided other checks, such as that the user has sufficient funds to cover the stake and that the requested odds remain valid, are met. As another example, for events which begin later than their scheduled start time, such as a tennis match which only starts when a previous match finishes, bets can be assessed based on whether play has actually started, as opposed to delaying all bets submitted after a notional start time.

Similarly, in certain examples, methods described herein may mitigate against disadvantages involved in suspending betting due to unfolding developments in a sporting event. For example, a suspension of a given market may be implemented by suspending the submission of bet requests relating to all outcomes available for selection for the given market. Where, for example, developments in the sporting event are unfolding that may affect the odds relating to an outcome in the “player to score” market, e.g., a given player appears to be injured, the market may be suspended in its entirety such that it not possible for users to submit bet requests relating to any of the players available for selection. In this situation, while the odds for the potentially-injured player scoring may be radically affected by whether the player is injured or not, the odds for other players to score may not be so affected. In certain examples, methods described herein may mitigate this disadvantage, since, because bet requests are checked at the time of submission against up-to-date state data, the market may remain open without risking accepting unsafe bets. In other words, the checking of bet requests against state data at the time of submission may allow the implementing a market-wide suspension to be avoided.

### Interactions Between Bet Execution Entity and Assessment System

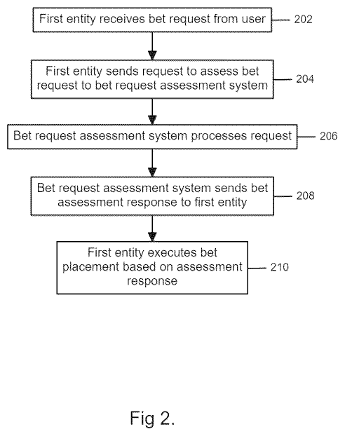

FIG. 2 is a flow diagram illustrating details of an example method in accordance with the method of FIG. 1. In particular, FIG. 2 shows an example in which the method involves interactions between a first entity and a bet request assessment system. The first entity may be configured to receive bet requests from users and execute bet placement. For example, the first entity may be a server operated on behalf of a bookmaker responsible for bet execution.

At block 202, the first entity receives a bet request from a user. The bet request may be received through various computing platforms, such as mobile applications, web browsers, or other user interfaces provided by the first entity.

At block 204, the first entity sends a request to assess the bet request to the bet request assessment system. This request may include details from the original bet request such as the stake amount, requested odds, and selected outcome.

The bet request assessment system processes the request at block 206. During processing, the system analyses state data relating to the sporting event to determine whether the bet should be accepted, as described in connection with FIG. 1.

At block 208, the bet request assessment system sends a bet assessment response to the first entity. The response indicates whether the bet should be accepted based on the analysis performed at block 206.

At block 210, the first entity executes bet placement based on the received assessment response. If the assessment response indicates the bet should be accepted, the first entity may proceed with placing the bet. The first entity may then notify the user about the status of their bet request through appropriate communication channels. Alternatively, if the assessment response indicates that the bet should not be accepted, the first entity may reject the bet and notify the user accordingly.

In some examples, as mentioned above, the first entity may be an entity operated by a bookmaker or other party which is responsible for receiving bet requests and may also be responsible for executing placement of bet requests. The distributed architecture described in this example may allow for specialised processing functions to be allocated between different systems. For example, the bet request assessment system can focus on analysing and evaluating bet requests, while the first entity manages bet placement. This separation allows each system to be optimised for its specific role while maintaining coordinated operation through defined interfaces.

In some examples, the bet request assessment system operates independently from a bookmaker platform including the bet execution entity. In this case, the sending of the bet assessment request may comprise the bet execution entity sending a request to an external server providing the bet assessment functionality. The separation between the bookmaker platform and the external bet request assessment system can provide independent evaluation of bet requests. This arrangement allows the assessment system to maintain operational independence while providing specialised assessment services to the bookmaker platform.

The external bet request assessment system architecture enables independent scaling and updating operations. The assessment system can be modified, upgraded or expanded separately from the bookmaker platform infrastructure. This separation allows maintenance and improvements to be performed on either system without impacting the operations of the other. Moreover, processing of state data can occur externally to the bookmaker platform through the bet request assessment system which may reduce computational demands on the bookmaker platform since analysis of state data happens separately. The external processing approach may reduce network traffic by eliminating the need to transfer state data to the bookmaker platform while still enabling comprehensive bet assessment. It may also allow the assessment system to make determinations based on data proprietary to the entity performing the assessment without providing the bookmaker with access to the underlying proprietary data on which the assessment is based.

In other examples, the first entity and the bet assessment system may both be implemented as a bookmaker's computing system that interfaces with both users and the bet request assessment system. For example, the bet assessment system may operate on a server controlled by the bookmaker. In this case, the bet execution entity and the bet assessment entity may, for example, operate on the same or different servers controlled by the bookmaker. The bet assessment system and bet execution system may in some cases, for example, operate within different “walled gardens”.

This integrated arrangement allows the first entity to handle user interactions and bet execution while leveraging the bet request assessment system's capabilities for evaluating bet requests against current state data. The integration of components within the bookmaker platform can facilitate rapid communication between the first entity and bet request assessment system. Direct interaction between these platform components may also reduce processing delays and communication overhead. Furthermore, the contained nature of the assessment system within the bookmaker platform supports protected handling of proprietary betting information. In such examples, the bet assessment system within the bookmaker platform may obtain the state data from a third-party, e.g., a provider of a live information feed. In other examples, the bookmaker platform may itself have the capability of acquiring state data directly, e.g., by using computer vision, human operators, or any other suitable data acquisition method or combination of methods, at sporting events.

### Determination of Bet Acceptance Criteria

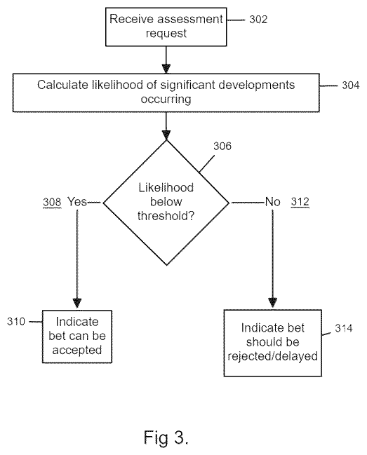

FIG. 3 is a flow diagram illustrating an example of processing performed by a bet assessment system assessing a bet request, which may be combined with any of the features described in relation to previous figures.

In particular, FIG. 3 shows example steps involving determining, based on the state data, a likelihood of the state data developing, in a pre-defined time interval following a time of receipt of an assessment request, in a manner indicative of a significant development in the sporting event, for example, a development in the sporting event which would significantly affect an estimated probability associated with the outcome. This likelihood may be taken into account in determining the indication of whether the bet should be accepted.

At block 302, an assessment request relating to a request to place a bet on a particular outcome in a sporting event is received. Following receipt of the assessment request, at block 304, a likelihood of the state data developing in a pre-defined time interval in a manner indicative of a significant development in the sporting event is calculated.

The likelihood of the state data developing in a significant manner in the pre-defined time interval may, for example, be a likelihood of a change in the state data which would cause an estimated probability associated with the outcome to change by a threshold amount, such as 2%, 5% or 10%, in the time interval. The threshold amount may be referred to herein as a significance threshold.

The probability associated with the outcome may be an estimated probability that the outcome will become a winning outcome. For example, various factors such as live game state data and historical statistics, may be taken into account to determine a probability of a given outcome occurring. The probability may be updated in real time, taking into account developments relating to the sporting event as they occur. Odds offered on the outcome may be calculated based on the estimated probability and additionally may be based on other factors such as liabilities and risk preferences of the bookmaker. Accordingly, when an estimated probability associated with a given outcome changes, the odds offered on the outcome may be changed in response.

The calculation of the likelihood may be performed by making inferences based on the state data. For example, a model, which may be a machine-learning model, may be applied to the state data to determine a risk factor indicative of the risk of one team scoring or any other significant event occurring in a predetermined period, such as the next 3, 5, 10 or 30 seconds.

Alternatively, or additionally, the likelihood may involve a more general assessment of the state of play of the sporting event to determine whether the sporting event is likely to develop in a manner which causes the probability of a given outcome to change by at least the significance threshold in the pre-defined time interval. For example, an assessment may be made based on the state data of whether the game is currently in a “high-leverage” situation in which the result of certain bets is very sensitively dependent on what happens in the next few seconds.

In some examples, in addition to or alternatively to using inferences from a machine-learning model, a rules-based approach may be taken. For example, the situation in the sporting event, such as whether a particular team is attacking or, in football, has been awarded a penalty kick or corner, may be assessed, for example, automatically by computer vision, or via manual human input, and used to determine the likelihood of the state data developing in a significant manner in the pre-defined interval.

At decision block 306, the system determines whether the calculated likelihood is below a likelihood threshold. The likelihood threshold may, for example, be set based on risk management factors relating to the entity being requested to accept the bet. Additionally, or alternatively, the likelihood threshold may be set based on one or more factor relating to characteristics of the bet request, market data or customer data, or any combination of such factors.

Similarly, in cases where a significance threshold is used in the determination of whether the state data is likely to develop in a significant manner in the near future, the significance threshold may be set based on risk management data, characteristics of the bet request, market data, customer data, or any combination of these.

For example, different bookmakers may have different approaches to accepting bets placed during periods of potentially rapid probability changes and may consider different magnitudes of change in probability to be significant, e.g., due to different risk tolerances.

In some examples, different significance thresholds and/or likelihood thresholds may be applied for different customers or different groups of customers. For example, a higher likelihood threshold may be set for highly trusted or valued customers, allowing bet requests for such customers to be accepted even during periods of potentially rapid odds changes, while a lower likelihood threshold may be set for other customers, to control the associated risk with accepting bets at odds which may soon become outdated or which may already be out of date.

In this example, if the determination at block 306 indicates the likelihood is below the likelihood threshold (“Yes” at 308), the process proceeds to block 310 to indicate the bet can be accepted. This indication is made when the likelihood is below the likelihood threshold, meaning that, based on the state data, the risk that the probability associated with the outcome will change rapidly following submission of the bet request is below an acceptable threshold and therefore the risk of accepting the bet at the requested odds is acceptably low. Acceptance of the bet in such cases may still be subject to other checks, such as that the user has a sufficient balance, risk management considerations, a check against the currently offered odds, and other such factors.

In this example, if the determination at block 306 indicates the likelihood is not below the likelihood threshold (“No” at 312), the process proceeds to block 314 to indicate the bet should be rejected or delayed. For instance, if it is determined that play is active and there is a high likelihood of a significant development in a pre-determined period following the bet request, then it may be determined that the bet should not be accepted, or should not be accepted at least until a delay period has expired. Accordingly, an appropriate response can be taken if it is determined that there is a high risk of a significant development in the near future and therefore a larger than acceptable risk that the bet will be accepted at odds which quickly become invalid or which are already invalid.

In other examples, other actions may be taken based on the indication that the likelihood is above the likelihood threshold. For example, if it is determined that any substantial change in probability is likely to be in the bookmaker's favour (e.g., the probability associated with the outcome to which the bet request relates is likely to significantly reduce), then the bet may be accepted. On the other hand, if the indication is that any substantial change in probability is likely to be adverse to bookmaker, then the bet may be rejected or a delay implemented. In another example, one or more other factors in the bet acceptance decision may be set based on the determined high likelihood of the probability changing significantly. For example, a lower maximum stake may be set, or betting may be restricted to a particular subset of trusted customers. The decision of whether to reject a bet outright or to apply a delay may also be dependent on other factors, such as one or more of the particular customer making the bet request, the bookmaker's liabilities and risk tolerances and the details of the bet, such as the requested stake. In certain examples, additional predictions may be made based on the state data, such as the likely magnitude of any probability change. Such additional information may also be taken into consideration when assessing the bet request.

By assessing bet requests in this manner, a risk associated with accepting bets based on outdated information regarding the state of the sporting event can be reduced. For example, if a user with access to a very fast data feed or, for example, a user present at the sporting event, submits a bet request immediately upon the occurrence of a significant development in the sporting event, then, at the time of receipt of the assessment request, the state data may not yet reflect the occurrence of the significant development. In such circumstances, by assessing the state data to assess the likelihood of imminent significant developments, the risk of accepting a bet when a significant development in the sporting event has already occurred can be mitigated.

The processing of bets requests with respect to periods of likely probability changes may follow different protocols depending on implementation requirements. This can include immediate acceptance or rejection based on confirmed events, waiting periods for event confirmation, or hybrid approaches combining multiple decision criteria. The timing and method of event confirmation may be customised based on the specific sporting event type and available data sources.

The use of likelihood thresholds and custom definitions of the magnitude of a potential probability change which is considered significant enables controlled and systematic bet acceptance decisions. Setting specific threshold values allows quantitative management of risk levels associated with probability-changing events. The thresholds can be adjusted to implement different risk tolerance levels and maintain consistent bet acceptance criteria across multiple events.

The assessment of bet requests can incorporate analysis of potential near-term probability-changing events that may occur within a defined time window. By evaluating the likelihood of such events based on current state data, the system can make informed decisions before market conditions shift. This predictive approach allows for more refined risk management through anticipation of probable developments rather than solely reacting to events after they occur.

### Example Bet Assessment Decision Flow

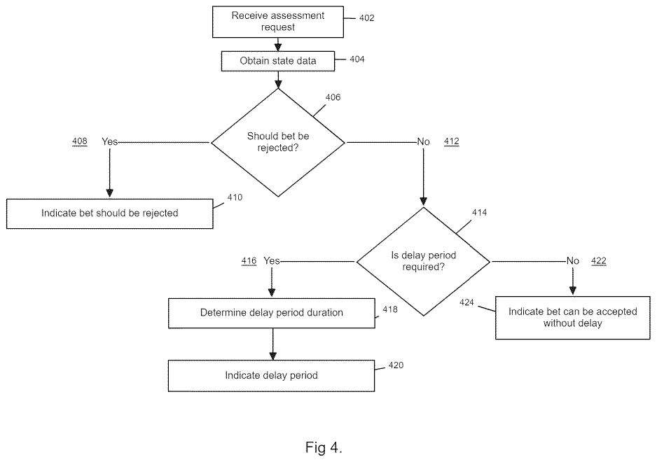

FIG. 4 is a flow diagram illustrating another example of processing performed by a bet assessment system assessing a bet request, which may be combined with any of the features described in relation to previous figures. In particular, FIG. 4 shows an example of steps for performing assessment of a bet request, including, in some cases, determining whether to implement a delay period in response to a bet request assessment based on state data analysis.

At block 402, a bet request is received for assessment. Following receipt of the request, at block 404, state data relating to the sporting event is obtained. The state data may include real-time information such as live video feeds, statistics, or other data indicating the current state of play, as described in relation to previous examples.

At decision block 406, the system evaluates whether the bet should be immediately rejected, according to one or more validation checks. For example, if the user has insufficient funds to cover the requested stake, or if the requested odds do not match the current odds, or if the market is suspended, or if the requested stake exceeds a maximum stake limit, then it is determined that the bet should be immediately rejected (“Yes” at 408). Responsive to this determination, at block 410, the system provides a bet assessment response indicating that the bet should be rejected.

If the system determines at block 406 that the bet is to not to be immediately rejected (“No” at 412), then the system proceeds to decision block 414, wherein the system evaluates the obtained state data to determine whether a delay period should be applied before determining whether to accept the bet. This determination may consider various factors derived from the state data, such as whether play is active or if there are indications of potentially significant events that could affect betting odds. For example, the decision that a delay period should be implemented may be made responsive to determining that the state data is likely to develop, in a following pre-determined period, in a manner indicating a significant development in the sporting event, as described in relation to FIG. 3.

The determination of whether to implement a delay period may also involve considering multiple contextual factors including characteristics of the bet request, user profile data, and organisational risk parameters. This multi-factor analysis enables refined calibration of delay timing based on the specific circumstances of each betting scenario. The combination of different data types allows for more precise risk management decisions that reflect both individual transaction factors and broader operational considerations.

In this example, if it is determined that a delay period should be implemented (“Yes” at 416), the process proceeds to block 418 where the system determines the duration of the delay period to be applied. This calculation may, for example, involve considering any of the factors which may be taken into account when determining whether to apply a delay. This allows for more refined control over bet acceptance timing based on the specific circumstances and risk profile of each betting situation.

At block 420, the system provides a bet assessment response indicating that the bet should not be accepted or rejected immediately but should instead be re-assessed when the delay period expires. This temporary rejection helps manage risk by managing bet acceptance, for example, during periods of potentially rapid odds changes. The indication is provided to a bet execution entity responsible for executing bet placement. Following the expiry of the delay period, the bet assessment system may determine, for example, based on the state data and any relevant validation checks such as those discussed above, whether the bet may be accepted or rejected. In some examples, the bet assessment system may automatically reassess the bet request following expiry of the delay period, while in other examples, the decision of whether to resubmit the bet request for assessment may be left with the bet execution entity.

If at block 414 it is determined that no delay period is required (“No” at 422), then, with the validation checks performed at block 406 having been passed, the system provides an indication at block 424 that the bet may be accepted without delay.

Since the decision of whether to accept a bet or to apply a delay is made on the basis of a specific bet request, in cases where the state data indicates that the bet is safe to accept without applying a delay, bets can be accepted immediately. This can avoid the drawbacks of universally applying a delay to all in-play requests while allowing delays to be used strategically to manage risk in situations where the state data indicates that this would be beneficial.

### Assessment of Bet Requests Made on Basis of Provisional Odds

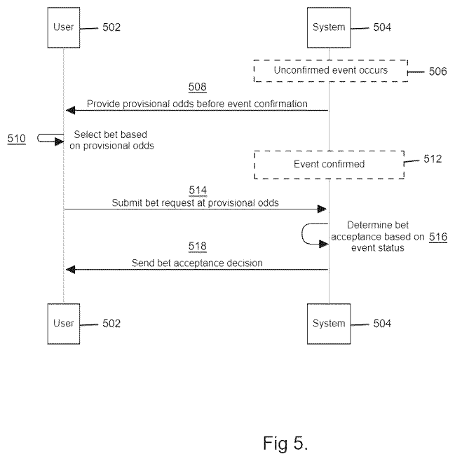

FIG. 5 is a sequence diagram showing an example scenario in which a bet assessment method according to that described in relation to previous figures is implemented.

FIG. 5 shows a system 504 in communication with a user 502.

The system 504 is configured to perform the functionality of providing odds to the user 502, receiving bet requests from the user 502, and performing bet execution. For example, the system 504 may perform the functions which are described in earlier examples as being performed by a bookmaker platform, involving presenting odds to a user, allowing the user to make bet selections, and handling bet placement.

Furthermore, in this example, the system 504 is also configured to perform the functionality of a bet assessment system, namely, as described in previous examples, assessing bet requests originating from the user 502 to provide an indication of whether such requests should or should not be accepted.

Moreover, in this example, the system 504 also includes functionality of determining market data, including odds and suspension data, to be presented to users.

The sequence diagram shows interactions between the user 502 and the system 504.

In a sporting event upon which the system 504 handles the placement of bets, in this example, a football match in a live in-play betting scenario, an unconfirmed event occurs at 506. This represents an event which, if confirmed, will significantly change the odds applicable to at least one outcome of one market relating to a sporting event. For example, the in-play market may be whether the home team wins, loses or draws, with each of these three options representing an outcome. In this example, the unconfirmed event 506 is a potential goal scored by the home team which has not yet been confirmed due to officials checking that the goal was valid, e.g., by verifying the scorer was not offside and that no foul was committed by the home team.

Immediately following the potential goal at 506, an odds calculating component of system 504 computes updated odds. These updated odds are conditional on the goal having been validly scored and until the goal is confirmed may be referred to as provisional odds. For example, if the goal by the home team is confirmed, then the odds on the outcome “home team to win” may be shortened. The provisional odds on this outcome may therefore be shorter than the applicable odds if the goal is disallowed.

The system 504 provides these provisional odds to the user 502 at 508, e.g., by updating the odds for the “home team to win” market presented to the user via their app or web browser. Since these provisional odds are conditional on the goal being confirmed, they are not valid for the placing of bets until the goal is confirmed. If the goal is later confirmed not to have occurred, e.g., the goal is disallowed, the provisional odds are rendered invalid, and new updated odds may then be provided.

Since the provisional odds can be quickly calculated and provided to the user 502 following the potential goal at 506, the user can view the betting market relating to the sporting event shortly after the potential goal. The user 502 can therefore make bet selections and prepare them for submission, with a minimal period of interruption while the updated provisional odds are provided. For example, the user 502 may see the updated (provisional) odds during the period where the officials are deciding whether to allow the goal.

At block 510, the user selects a bet based on the provisional odds. For example, the user selects a bet on home team to win at the updated, shorter odds.

At block 512, the event is confirmed to have occurred. For example, following the check by the officials, a goal is confirmed to have been scored.

The user submits a bet request via message 514, with the request indicating the provisional odds. The system performs a bet assessment process 516 which checks that the goal has been confirmed. In this case, since the goal has been confirmed at 512, the check at 516 confirms that the provisional odds are valid. The system 504 then continues with any further bet assessment checks and determines whether the bet should be accepted. In this example, it is determined that the bet can be accepted. The system 504 then handles placement of the bet and sends a bet acceptance decision to the user 502 via message 518.

In this example, the goal is confirmed to have occurred at 512 prior to submission of the bet request at 514. However, if, in the alternative, it had been confirmed at the time of receiving the bet request that the goal did not occur, then the bet would be rejected since the provisional odds would not be valid. In another scenario, if the bet request were submitted while confirmation of the goal remained pending, the bet could be rejected or a delay could be applied until the goal is either confirmed or denied.

The described approach of offering provisional odds that are conditional on specific events enables market participation to begin earlier in the process. Users can view and prepare bet selections based on these provisional odds while waiting for event confirmation. This maintains appropriate risk management since the provisional odds only become valid for bet acceptance once the underlying event is confirmed to have occurred.

The odds provided to users may be calculated and updated through different mechanisms, taking into account various factors including but not limited to historical data, current market conditions, and real-time event developments. The system may implement different strategies for odds adjustment based on the volume and pattern of incoming bet requests.

While in the example shown in FIG. 5 the provisional odds are conditional upon confirmation of a particular event which significantly affects the odds relating to the outcome occurring, a similar approach may be used in other circumstances. For example, the provisional odds may be conditional upon confirmation of a provisional result of any passage of play in the sporting event. As an example, in sports which are broken into discrete units of play, such as American football or tennis, a provisional result (e.g., number of yards gained, or the winner of a given point) may be entered immediately after the passage of play is complete, with the result being confirmed shortly thereafter, with occasional longer delays in confirmation or a possibility of a correction if the initial assessment was incorrect or is overturned by officials.

In such examples, a similar approach to that described above with reference to FIG. 5 may be used, whereby provisional odds conditional on the provisional result being confirmed are provided to the user immediately after the completion of the passage of play. The user may then browse these provisional odds and submit bet requests. When a bet request is received requesting the provisional odds, a check may be performed of whether the provisional result has been confirmed. If so, the provisional odds are considered valid and the bet may be accepted, subject to any other applicable checks. If the provisional result has since been negated (for example, the initial assessment has been corrected) then the bet request may be rejected, while if confirmation of the provisional result remains pending, the bet request may be rejected or a delay implemented.

### Computing Apparatus

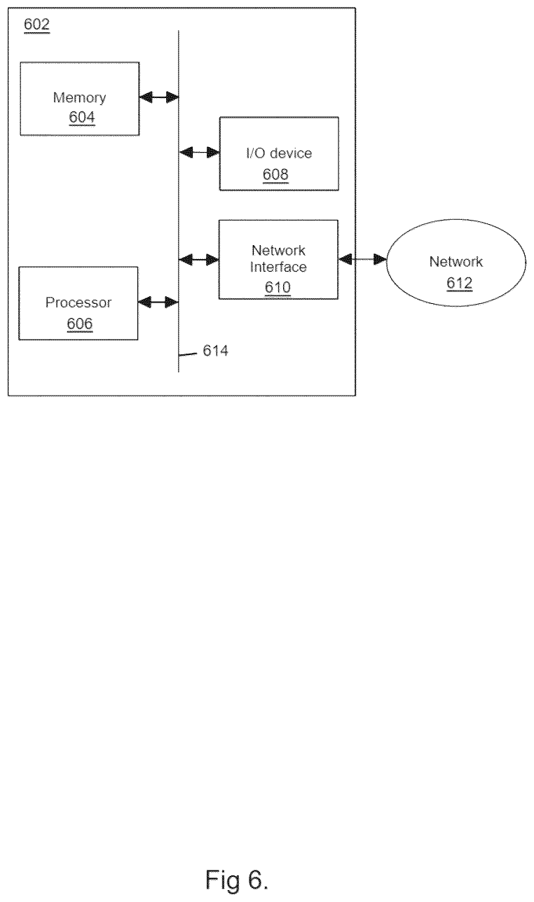

FIG. 6 is a block diagram illustrating an example of a computing apparatus 602 that may be used to implement any of the examples described herein. For example, computing apparatus 602 may be configured to perform the functions of an example bet assessment system, and/or the above-described functions of entity responsible for handling bet execution.

Computing apparatus 602 includes memory 604 and one or more processors 606. Memory 604 may store instructions that, when executed by the one or more processors 606, cause the processors to perform operations for assessing bet requests relating to sporting events. These operations may include, in the case of a bet assessment system, receiving requests to assess bet requests, determining indications of whether bets should be accepted based on state data, and providing bet assessment responses.

The apparatus 602 includes one or more input/output (I/O) devices 608 that enable user interaction with the system. The one or more I/O devices 608 may include an input device, such as a positional input device, e.g., a mouse, touchpad, touchscreen, or the like; a keyboard, button, switch, or the like; and/or other human and machine interface devices. The one or more I/O devices 608 may include an output device such as a display, e.g., a liquid crystal display (LCD), light emitting diode (LED) display (such as an OLED display), or other suitable display.

A network interface 610 enables communication over a network 612, such as a local area network (LAN) or a wide area network (WAN), like the Internet. Through network interface 610 and network 612, the apparatus 602 may receive requests to assess bet requests and state data relating to sporting events, and transmit bet assessment responses. The network interface 610 may include one or more wired or wireless network adaptors. The apparatus 602 may communicate with other devices via the network interface 610 using one or more network protocols such as Ethernet, Internet Protocol (IP), Transmission Control Protocol (TCP), User Datagram Protocol (UDP), wireless network protocols such as Wi-Fi, Long Term Evolution (LTE) protocol, or other suitable protocols.

The one or more processors 606 may execute instructions stored in memory 604 to process received bet requests. This processing may include analysing state data to determine whether play is active in a sporting event, calculating likelihoods of probability-changing events occurring, implementing delay periods, and validating provisional odds. The processors 606 generate bet assessment responses based on this analysis.

The one or more processors 606 may be configured in various hardware architectures, including distributed processing systems, cloud-based implementations, or local server configurations. The processing resources may be allocated dynamically based on system load and assessment requirements. The one or more processors 606 may be or include any suitable processor, processing unit, or microprocessor. The processor 606 may include one or more general processors, digital signal processors (DSPs), application specific integrated circuits (ASICs), field programmable gate arrays (FPGAs), analogue circuits, digital circuits, programmed processors, and/or combinations thereof, for example. The processor 606 may be a multi-core processor, which may include multiple processing cores of the same or different type.

Memory 604 may store various types of data used in bet request assessment, such as state data relating to sporting events, threshold values for likelihood calculations, parameters for delay periods, and data relating to provisional odds. The memory 604 may also store historical data and models used in analysing state data and making assessment determinations. The memory 604 may comprise, for example, volatile and/or non-volatile storage media, such as, random access memory, read-only memory, programmable read-only memory, electrically programmable read-only memory, electrically erasable read-only memory, flash memory, or any combination of these.

A communication bus 614 is configured for communicating data between components of the computing system 602.

### Computing System Architecture and Network Configuration

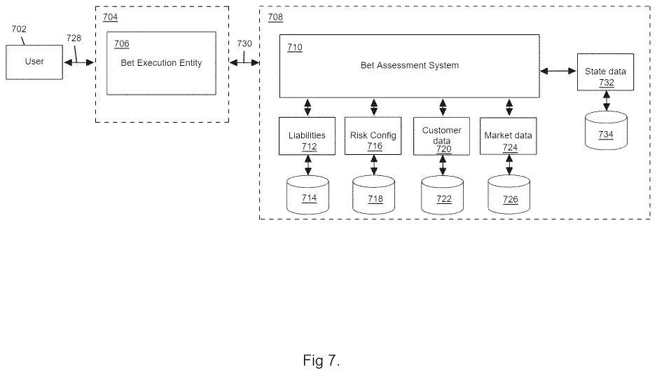

FIG. 7 is a block diagram illustrating, schematically, a networked computing system in which methods described herein can be implemented. The system may be implemented using cloud computing servers or other distributed computing architectures. A user 702, for example, using a smartphone app or web browser, interacts with a bookmaker platform 704 via a network connection 728, such as an internet connection. The bookmaker platform 704 provides betting services to the user 702 and one or more other users (not shown), presenting odds and betting opportunities and allowing users to browse potential markets relating to in-play betting opportunities, view odds and data about market suspensions and place bets. The user 702 may deposit money with the bookmaker platform 704 and maintain an account for placing bets on outcomes relating to various sporting events.

The bookmaker platform 704 includes a bet execution entity 706 that receives bet requests from users, including the user 702, and executes bet placement. The bookmaker platform 704 communicates with a market data and bet assessment platform 708 via a network connection 730.

In this example, the market data and bet assessment platform 708 operates externally to the bookmaker platform 704 and includes a bet request assessment system 710. For example, the platform 708 may be operated by a third party which provides bet assessment services to the bookmaker platform 704. When the bet execution entity 706 receives a bet request from the user 702, it sends an assessment request to the bet request assessment system 710.

The bet assessment system 710 communicates with various servers of the platform 708 to obtain data to be used to evaluate assessment requests. In particular, the bet request assessment system 710 communicates with a liabilities server 712, a risk configuration server 716, a customer data server 720, a market data server 724, and a state data server 732.

The liabilities server 712 is in communication with liabilities database 714 which is used to store data relating to bookmaker liabilities for particular sporting events, markets, or outcomes. For example, the liabilities database 714 may include a ledger of all betting transactions of the bookmaker operating the platform 704, or at least all transactions which are relevant to assessment requests sent from the bet execution entity 706 to the bet assessment system 710.

The risk configuration server 716 is in communication with a risk configuration database 718 used to store risk configuration rules and/or preferences for the bookmaker. These may include bookmaker-specified risk preferences, such as maximum liability limits, and likelihood thresholds. The database 718 may also, for example, store bookmaker-specific settings relating to rules for implementing delays, and for processing of bet requests from customers with different attributes.

The customer data server 720 is in communication with a customer data database 720 which maintains information relating to particular customers of the bookmaker, including the user 702. The customer data database 720 may include, for example, information on customer betting history and behaviour patterns. The database 720 may also include indicators of customer status, such as designation of customers deemed highly valuable or highly trusted which may be used in conjunction with preferences stored in the risk configuration database 718 to provide differentiated processing of bet requests from different groups of customers.

In some examples, some or all of the data in the liabilities database 714, risk configuration database 718, and customer data database 722 may be obtained from the bookmaker platform 704. For example, the bookmaker platform 704 may provide information on its current liabilities, as well as customer data and risk preferences to the platform 708 via the network connection 730.

The market data server 724 provides access to market data stored in database 726, including odds and suspension data relating to betting outcomes. The market data in some cases may be generated by an entity operating the platform 708. For example, the platform 708 may operate as a third-party odds provider which generates and provides information to bookmakers such as the operator of the bookmaker platform 704. In other examples, the platform 708 may obtain the market data via an external source or may be provided with the data from the bookmaker platform. For example, the market data may be obtained from another third-party odds provider by subscribing to a particular odds feed, or by scraping the web for odds.

The state data server 732 retrieves state data from database 734 relating to the current state of play in sporting events, which may include video feeds, audio, statistics, and other real-time information. As described in previous examples, the state data may be generated or acquired by the entity operating the platform 708, or in other examples, the state data may be obtained from another source, e.g., a third-party data provider. The state data may be continuously updated to provide a real-time indication of the state of play of the sporting event, as the event progresses.

When processing a bet request, the bet request assessment system 710 analyses the available data, including the state data, to determine whether the bet should be accepted. The assessment process may involve any of the features described with reference to previous examples. The system then provides a response to the bet execution entity 706, which determines an appropriate action based on the assessment, such as accepting or rejecting the bet. The bet execution entity 706 then executes the determined action and notifies the user 702 of the outcome.

Although not shown in FIG. 7, it will be appreciated that the platform 708 may provide one or more bet assessment and market data provision services to one or more further bookmaker platforms via a similar means to that described for the bookmaker platform 704.

Furthermore, one or more of the liabilities server 712, liabilities database 714, risk configuration server 716, risk configuration database 716, customer data server 720, customer data database 722, market data server 724, market data database 726, state data server 732, and state data database 734, may be located externally to the platform 708.

### Additional Variations

Various modifications and alternatives may be implemented. For example, any combination of state data and other data, such as liabilities, risk configuration, customer data, market data, etc., may be used to perform bet assessment processes according to certain methods described herein. For example, a bet assessment system may determine bet assessment indications based only on state data without taking other data into account. In other examples, the assessment may be multi-factorial.

Additionally, any of the functions described as being performed by a bet assessment system and by a bet execution entity in some circumstances may be performed by a single entity, or by additional further entities. Moreover, additional functions, such as the computing of market data and the acquiring of state data may be performed by the bet assessment system or an entity responsible for operating the bet assessment system or by a different entity, such as one or more third-party data providers.

The above embodiments are to be understood as illustrative examples of the invention. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A computer-implemented method of assessing a bet request, the method comprising:
receiving, at a bet request assessment system, a request to assess a bet request, the bet request being a request from a user to place a bet on an outcome relating to a sporting event;
determining, at the bet request assessment system, based on state data indicative of a state of play of the sporting event, an indication of whether the bet should be accepted; and
providing, by the bet request assessment system, a bet assessment response in accordance with the determined indication.

2. The method of claim 1 wherein the request to assess the bet request is received by the bet request assessment system from a first entity configured to receive bet requests from users and to execute bet placement, and wherein the bet request assessment system provides the bet assessment response to the first entity.

3. The method of claim 2, wherein the first entity is a part of a bookmaker platform, and wherein the bet request assessment system is external to the bookmaker platform; or wherein the first entity and the bet request assessment system each form part of a bookmaker platform.

4. The method of claim 1, wherein the determining the indication of whether the bet should be accepted is based on a likelihood, determined based on the state data, of, in a pre-defined time interval following a time of the receiving the request to assess the bet request, the state data developing in a manner indicative of a significant development in the sporting event.

5. The method of claim 4, comprising determining that the bet should be accepted if the likelihood is determined to be below a given likelihood threshold.

6. The method of claim 5, wherein the determining the likelihood of the state data developing in a manner indicative of a significant development in the sporting event comprises:
determining a likelihood of the state data developing in a manner which would change an estimated probability associated with the outcome by a threshold amount.

7. The method of claim 1, wherein the determining the indication of whether the bet should be accepted comprises applying a trained machine-learning model to the state data.

8. The method of claim 1, wherein the determining the indication of whether the bet should be accepted is based on one or more of:
bet request data relating to a characteristic of the bet request;
market data relating to the outcome to which the bet relates;
customer data relating to the user; and
risk management data relating to an entity being requested to accept the bet.

9. The method of claim 8, wherein the risk management data comprise one or more of:
information indicative of existing liabilities, with respect to the sporting event, of the entity being requested to accept the bet; and
information indicative of one or more risk preferences, with respect to the sporting event, of the entity being requested to accept the bet.

10. The method of claim 1, wherein the determining the indication of whether the bet should be accepted comprises:
determining, based on the state data, that the bet should not be accepted at least until expiry of a delay period.

11. The method of claim 10, wherein the determining that the bet should not be accepted at least until expiry of a delay period is further based on one or more of:
bet request data relating to a characteristic of the bet request;
market data relating to the outcome to which the bet request relates;
customer data relating to the user; and
risk management data relating to an entity being requested to accept the bet.

12. The method of claim 10, comprising determining a duration of the delay period based on one or more of:
the state data relating to the state of play of the sporting event;
bet request data relating to a characteristic of the bet request;
market data relating to the outcome to which the bet request relates;
customer data relating to the user; and
risk management data relating to an entity being requested to accept the bet.

13. The method of claim 10, comprising:
responsive to expiry of the delay period, determining, based on the indication of the bet request and the state data, a further indication of whether the bet should be accepted, and wherein the bet assessment response is in accordance with the further indication.

14. The method of claim 1, wherein the determining the indication of whether the bet should be accepted comprises:
determining, at or before a time of the determining the indication and based on the state data, a confirmation status of a provisional result of a passage of play in the sporting event.

15. The method of claim 14, wherein the confirmation status is indicative of one or more of:
that the provisional result has been confirmed and thereby become a confirmed result;
that the provisional result has been negated; and
that confirmation of the provisional result remains pending.

16. The method of claim 14, wherein the bet request is a request to place a bet on the outcome at provisional odds whose validity is conditional upon the provisional result of the passage of play in the sporting event becoming a confirmed result.

17. The method of claim 16, wherein the bet request is a request to place a bet on the outcome at the provisional odds, and wherein the determining the indication of whether the bet should be accepted comprises determining, at or before the time of the determining the indication and based on the state data, the confirmation status of the provisional result of the passage of play.

18. The method of claim 17 comprising one or more of:
responsive to determining that the confirmation status indicates that the provisional result has become a confirmed result, determining that the bet should be accepted;
responsive to determining that the confirmation status indicates that the provisional result has been negated, determining that the bet should not be accepted; and
responsive to determining that the confirmation status indicates that confirmation of the provisional result remains pending, determining that the bet should not be accepted at least until expiry of a delay period or that the bet should be rejected.

19. A non-transitory computer-readable storage medium including instructions that, when executed, cause one or more processors of a bet assessment system to perform a method of assessing a bet request, the method comprising:
receiving, at the bet assessment system, a request to assess a bet request, the bet request being a request from a user to place a bet on an outcome relating to a sporting event;
determining, at the bet assessment system, based on state data indicative of a state of play of the sporting event, an indication of whether the bet should be accepted; and
providing, by the bet assessment system, a bet assessment response in accordance with the determined indication.

20. A system for receiving and processing bet requests, the system comprising:
a first entity for receiving bet requests from users and for executing bet placement with respect to the received bet requests; and
a bet request assessment system;
the system for receiving and processing bet requests being configured to:
receive, at the first entity, a bet request from a user, the bet request being a request to a place a bet on an outcome relating to a sporting event;
send, from the first entity to the bet request assessment system, a request to assess the bet request;
receive, at the bet request assessment system, from the first entity, the request to assess the bet request;
determine, at the bet request assessment system, based on state data indicative of a state of play of the sporting event, an indication of whether the bet should be accepted; and
send, by the bet request assessment system to the first entity, a bet assessment response in accordance with the determined indication; and
receive, at the first entity, the bet assessment response.
